(19) United States
(12) Patent Application Publication
(10) Pub. No.: US 2009/0083640 A1
(43) Pub. Date: Mar. 26, 2009

(54) STRING BASED USER INTERFACE SPECIFICATION

(75) Inventor: Channing P. Verbeck, Woodinville, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/859,734

(22) Filed: Sep. 21, 2007

(51) Int. Cl. G06F 3/048; G06F 3/01

(52) U.S. Cl. 715/760; 715/762

(57) ABSTRACT

Displaying a graphical user interface control may involve assigning a user-authored string of text to the graphical user interface control. The user-authored string of text may comprise text to be displayed verbatim as text when the graphical user interface control is displayed, and the user-authored text may further comprise embedded parameter references that comprise one or more characters in the string that distinguish the embedded parameter references from the text that is to be displayed verbatim. The user-authored string of text may be parsed to identify the embedded parameter references. Graphical user interface control may be displayed, which may involve displaying a sentence or phrase comprising the text to be displayed verbatim and displaying the interactive graphical user interface controls. The interactive graphical user interface controls may be displayed in positions in the displayed sentence or phrase that correspond to respective positions of the embedded parameter references in the user-authored string of text.

### BACKGROUND

User interface technology has seen an increase in the use of sentence-style user interfaces. A sentence-style user interface is a sentence or phrase of text that is displayed with user interface controls or functionality displayed as part of the displayed sentence or phrase. To see an example, see user interface element 132 of FIG. 2. Sometimes sentence-style user interfaces are implemented as a type of user interface control. Sentence-style user interfaces have been programmed or defined using existing coding techniques. For example, some blocks of source code might be written to specify respective chunks of static text of a sentence/phrase and some other blocks of source code might be written to specify respective user interface controls (e.g., dropdown lists, date pickers, etc.) that are to be included as part of the sentence/phrase when the blocks of code are executed. A text property of such a user interface control may be displayed as text of the sentence/phrase. For example, when the sentence “The cow jumped over the moon” is displayed, the text “moon” might actually be displayed by a dropdown list, where “moon” is an item selected from among a dropdown list of items, for example “star”, “fence”, and “moon”.

This technique of programming sentence-style user interfaces has some shortcomings. The necessary source code can be awkward to write and difficult to maintain. If a sentence/phrase and user interface controls to be displayed therein need to be translated from one language to another (e.g., from English to Spanish), then some source code that provides the user interface controls may need to be significantly rewritten, possibly requiring significant programming time and skill.

### SUMMARY

The following summary is included only to introduce some concepts discussed in the Detailed Description below. This summary is not comprehensive and is not intended to delineate the scope of the claimed subject matter, which is set forth by the claims that follow the Detailed Description.

Displaying a graphical user interface control may involve assigning a user-authored string of text to the graphical user interface control. The user-authored string of text may comprise text to be displayed verbatim as text when the graphical user interface control is displayed, and the user-authored text may further comprise embedded parameter references that comprise one or more characters in the string that distinguish the embedded parameter references from the text that is to be displayed verbatim. The user-authored string of text may be parsed to identify the embedded parameter references. Graphical user interface controls may be displayed, which may involve displaying a sentence or phrase comprising the text to be displayed verbatim and displaying the interactive graphical user interface controls. The interactive graphical user interface controls may be displayed in positions in the displayed sentence or phrase that correspond to respective positions of the embedded parameter references in the user-authored string of text.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a system for executing code to display a graphical user interface (GUI).

FIG. 2 shows an example of sentence-style user interface using previous coding techniques.

FIG. 3 shows a rewrite of the code of FIG. 2 incident to translation to a different language.

FIG. 4 shows how a formatted string literal can be used to facilitate rewriting (e.g., translation) of a sentence-style user interface.

FIG. 5 shows an example in declarative code using markup.

FIG. 6 shows an example in imperative code.

FIG. 7 shows a process for executing code with strings that have embedded user interface controls.

FIG. 8 shows another process for generating sentence-style user interface.

### DETAILED DESCRIPTION

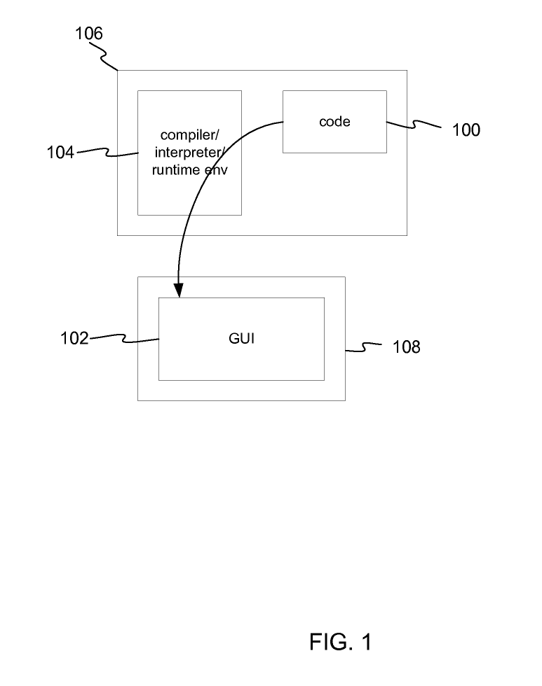

FIG. 1 shows a system for executing code 100 to display a graphical user interface (GUI) 102. The code 100 can be markup source code, functional/imperative source code, intermediate bytecode, etc. As discussed later, the code 100 will contain one or more strings containing text to be displayed. The text of a string will be in the form of ordinary text intended to be read by humans (e.g., text of a sentence or phrase that is to be displayed essentially verbatim), and parameter references or markers (e.g., “{0}”, “\c1”, etc.) that indicate locations within the string where the user interface controls are to be displayed, typically as part of a sentence or phrase.

The code 100 is processed by an execution unit 104, which might be a compiler, an interpreter, managed code environment (e.g., Java, .Net), or anything that receives code and executes code. The execution unit 100 may be running on any computing device 106, such as a workstation, a mobile computing device, a server, a laptop computer, and so on. The execution unit 100 causes GUI 102 to be displayed on a display 108 according to the code 100. User input devices (not shown) may be used to interact with the GUI 102, including user interface controls displayed due to their being referenced in a sentence-style string.

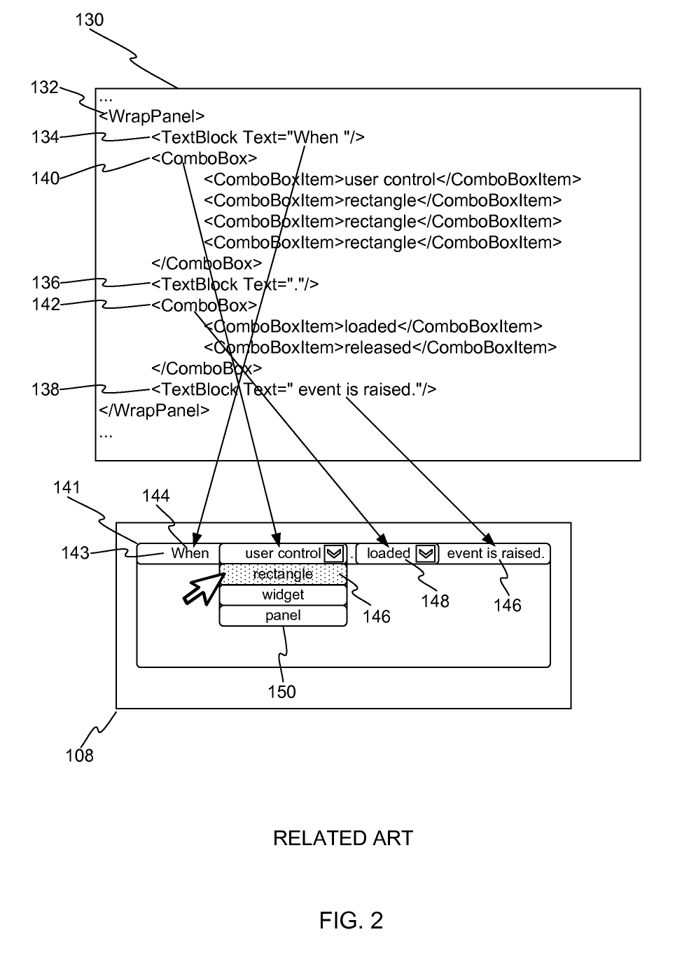

FIG. 2 shows an example of sentence-style user interface using previous coding techniques. Code 130 (an example of code 100) consists of markup code that declaratively defines a user interface element 132, in this case a WrapPanel. WrapPanel element 132 declares the WrapPanel. Various TextBlock elements 134,136,138 define the text to be displayed as part of the WrapPanel. Two ComboBox elements 140, 142 define two combo boxes to be displayed as user interface controls of the WrapPanel.

Code 130, when executed, will cause GUI 141 to be displayed on display 108. As can be seen in FIG. 2, a sentence-style user interface 143 (“When . . . is raised.”) is displayed. The sentence-style user interface 143 has text 144, 146 that corresponds to TextBlocks 134, 136, respectively. The sentence-style user interface 143 also has user interface controls 148, 150 that correspond to the respective ComboBox elements 140,142.

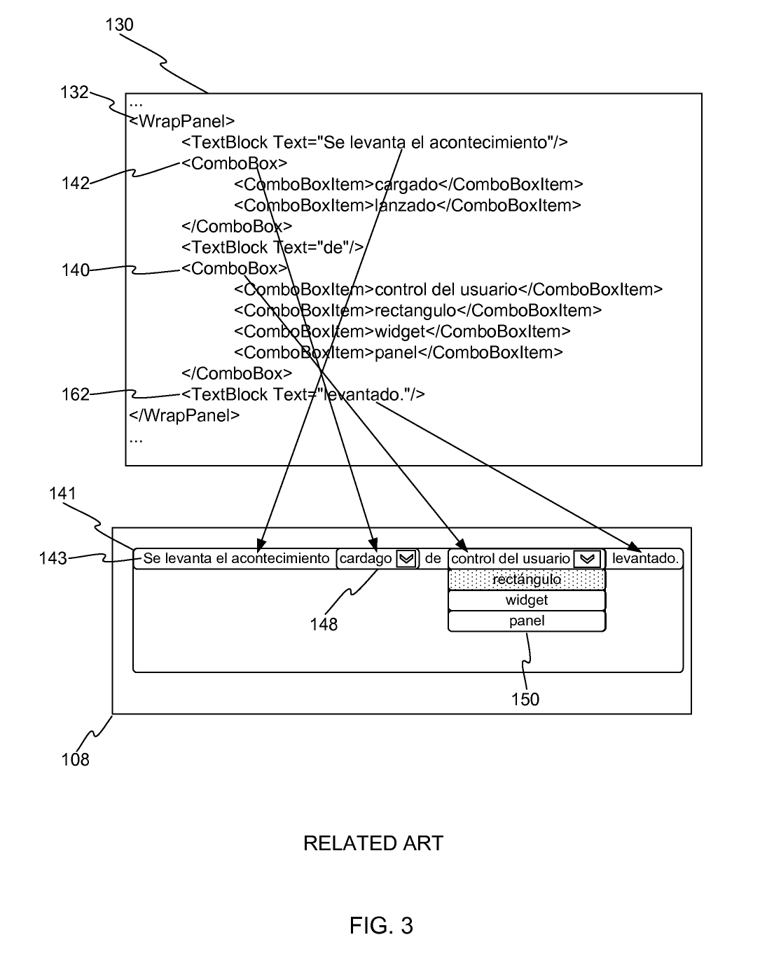

A notable feature of the example in FIG. 2 is that the sentence-style user interface 143 is defined with multiple intermingled declarations of text and user interface elements. Although one sentence or phrase is desired to be displayed, multiple program elements are needed. An equivalent in imperative code (e.g. C#) would include multiple statements to program the sentence-style user interface 143. This approach of sentence-style coding makes it difficult to translate the code 130 to another language, for example, Spanish. Language translation, whether by human or machine, often requires words of a sentence to be rearranged, sometimes changing the order of words of the sentence, as seen in FIG. 3.

FIG. 3 shows a rewrite of the code of FIG. 2 incident to translation to a different language. As shown in FIG. 3, the combo boxes 142/148 and 140/150 have been reordered within the text of the sentence. The TextBlocks that define the text for the sentence of the sentence-style user interface 143 have been revised and new TextBlocks such as TextBlock 162 have been added. Translation to Spanish requires significant revision of the code 130. A human translator may not have the skill to modify the code 130. A machine translator may not be able to identify the complete text sentence because of the way the text of the sentence is broken into separate pieces of code (in this example, TextBlocks).

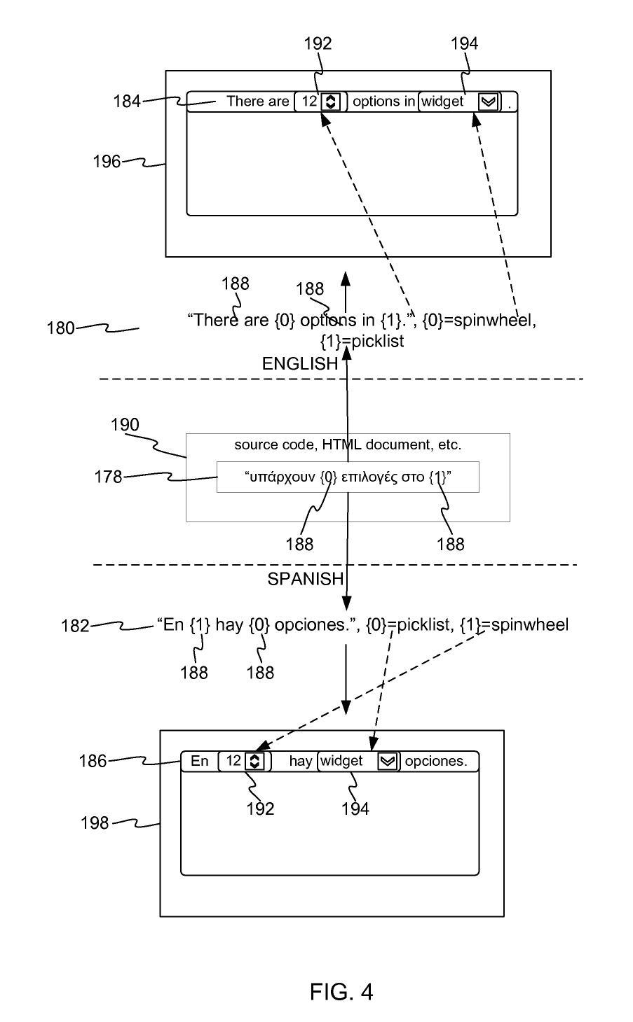

FIG. 4 shows how a formatted string literal 178, 180, 182 can be used to facilitate rewriting (e.g., translation) of a sentence-style user interface. String literals 180, 182 define sentence-style user interfaces 184, 186, respectively. Details on implementing string literals 178, 180, 182, and other embodiments of the general concept, will be explained further below. String literals facilitate rewriting of sentence-style user interface code because the text of the sentence/phrase and markers for user interface controls are included in one discrete (delineated, quoted, etc.) string. To rewrite the sentence/phrase to another language, a translator will typically not need to deal with multiple blocks of source code, although some reordering of blocks of code might be necessary, depending on the particular implementation. This will be discussed later.

As seen in FIG. 4, a string literal 178 in document or code 190 might exist originally in some language such as Greek. A person or program tasked with maintaining the code 190 may need to translate the sentence/phrase of the string literal 178 to English and Spanish. Because the sentence/phrase is intermingled with markers 188 (parameter references) in one string (string literal 178), it is possible to rewrite the sentence/phrase of string literal 178 by translating its substantive text, and possibly rearranging and/or reordering the markers 188 or parameter references embedded therein. Translated string literals 180, 182 can easily be coded from string literal 188 without having to rewrite major portions of associated user interface code in code 190 (in FIG. 4, the code following the strings is unchanged). Furthermore, as can be seen in FIG. 4, each string literal 180, 182 results in an analogous sentence-style user interface 184, 186, with text and controls 192,194 displayed on a display 196,198.

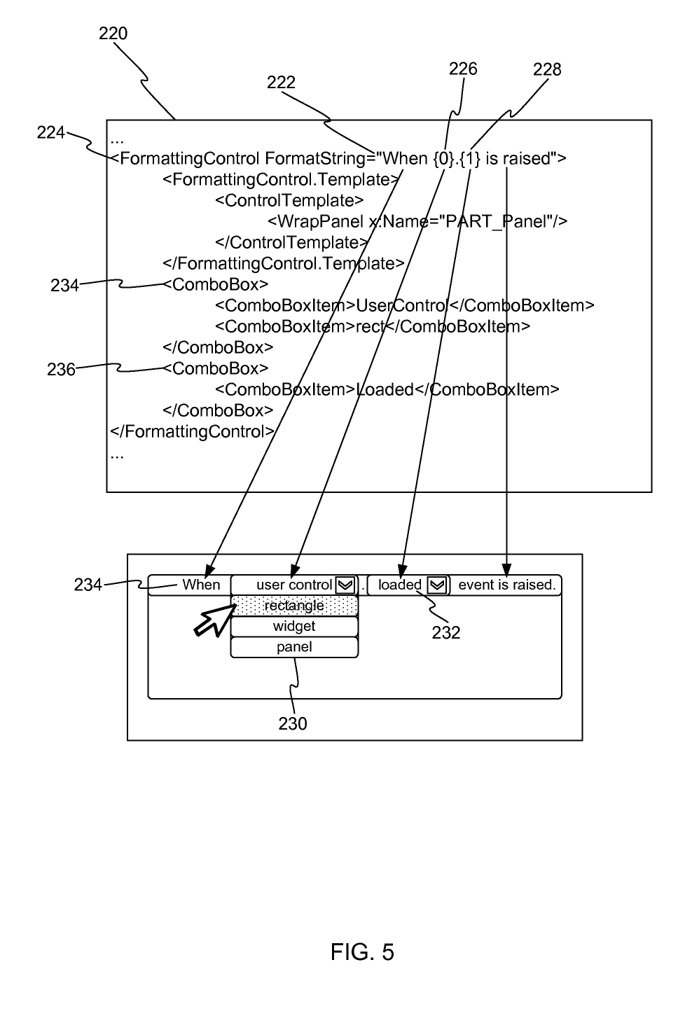

FIG. 5 shows an example in declarative code using markup. In this example of string-based sentence-style user interface definition, a string 222 is assigned as an attribute (the “FormatString” attribute) of a markup element 224 that defines a user interface control which, in the example, is called a “FormattingControl”. The string 222 has two markers 226, 228 embedded therein, which indicate where user interface controls are to be displayed as part of the sentence of string 222. In this example, the controls that will be displayed, dropdown boxes 230 and 232, are defined as elements 234, 236 within the FormattingControl markup element 224. However, the controls can be defined or coded anywhere in code 220, or even outside code 220, as long as there is some indication, preferably in proximity to string 222, about what controls correspond to the markers 226, 228. For example, the controls 230, 232 could be defined elsewhere and could be referenced with attributes of the FormattingControl markup element, e.g.: <. . . FormatString=“When {0}.{1} is raised” Parm0=ComboBox0Parm1=ComboBox1>”. As the ComboBox examples show, the controls 230, 232 may be of a type that can be interacted with by a user. They might also be non-interactive, for example, a non-interactive dropdown list whose current selection is changed by some automated process.

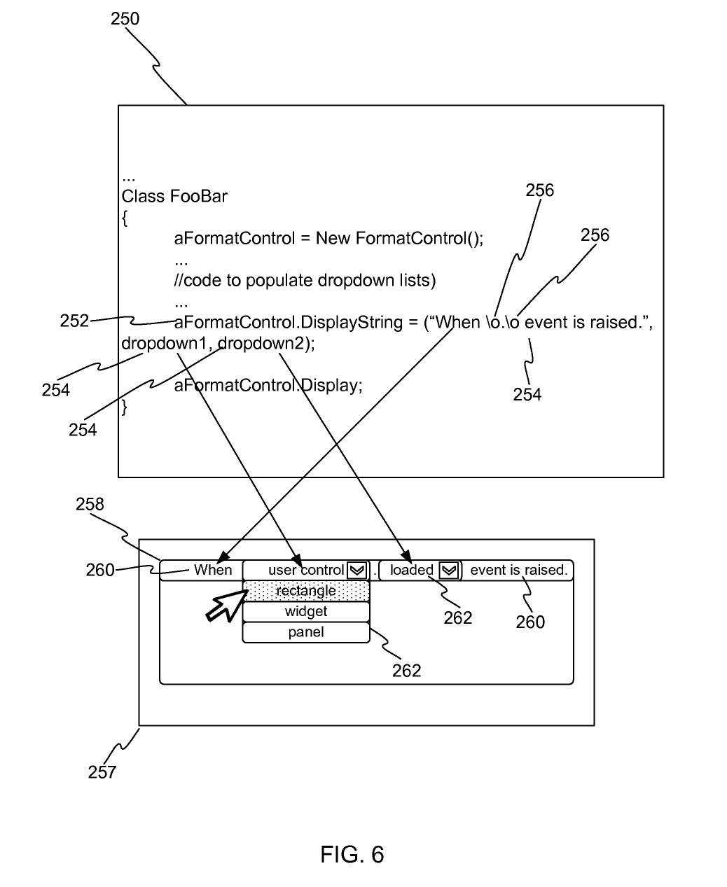

FIG. 6 shows an example in imperative code 250 (e.g., C#). Embodiments can be implemented in imperative code as well as declarative code. In code 250, a FormatControl is instantiated and two dropdown lists are populated. Three parameters are assigned to a DisplayString property of the FormatControl; a string 254 containing markers 256, and two control user interface controls 254. When the code 250 is executed, the FormatControl is displayed on display 257 as a user interface element 258 with text 260 and user interface controls 262. As with other embodiments discussed above, a literal string, quoted or otherwise delineated, is used to define a sentence-style user interface; a user interface with a text sentence/phrase having static intermingled with the text displayed by user interface controls. Although not required, typically the text of the user interface controls may be semantically integral to the sentence/phrase; the sentence/phrase makes sense when read as a combination of ordinary or static text (e.g. “When”, “event is raised”, etc.) and text contributed by a user interface control. In the example of FIG. 6, although a string literal is assigned to the DisplayString property, a variable pointing to the same string, or an object or function that returns such a string could also be used in the assignment statement. In any case, a string would be assigned to the control that will display the string and its referenced user interface controls.

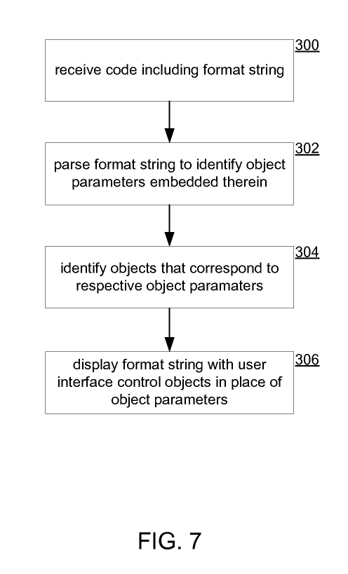

FIG. 7 shows a process for executing code with strings that have embedded user interface control objects. The process of FIG. 7 might be performed by a managed code environment, a web browser applet, a user interface authoring tool, or anything that executes code and generates a graphical user interface. Code is received 300, either from a local storage and/or via a network (e.g., as an HTML page, bytecode, JavaScript code, Extensible Application Markup Language, etc.). The code has a format string, which may be a string literal as discussed above. The format string in received 300 code is parsed 302 to identify parameters or markers (e.g., “{0}”, “\0”, or “\o”, etc.) that indicate where user interface control objects are to be displayed when the string is displayed. User interface control objects that correspond to respective parameters or markers may need to be identified 304, either before or after the parsing 302. Finally, the format string is displayed 306 with the user interface control objects displayed in locations in accordance with the locations of the parameters or markers in the format string.

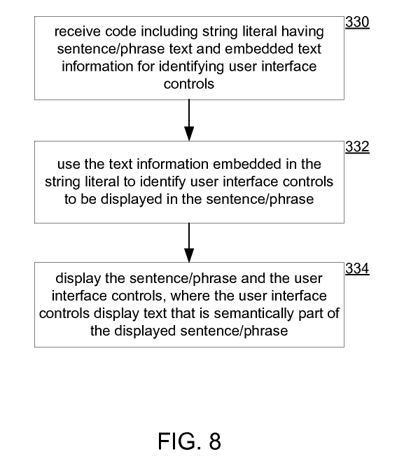

FIG. 8 shows another process for generating sentence-style user interface. Code is received 330 and the code includes one or more string literals having sentence/phrase text and embedded text information for identifying user interface controls. The text information embedded in the string literal is used to identify user interface controls to be displayed in the sentence/phrase. In one embodiment this involves matching the text information for identifying user interface controls (e.g., markers) with indicia of the user interface controls (e.g., function parameters naming the user interface controls, markup language sub-elements, etc.). The matching may be based on order; the first marker in the string literal is matched with indicia of a first user interface control (e.g., first parameter or first sub-element), the second marker is matched with indicia of a second user interface control, and so on. The matching may be based on information in the markers themselves. For example, marker “{0}” would be matched with a first identified user interface control, marker “{1}” would be matched with a second identified user interface control, etc., regardless of the order of the markers in the string literal. There are too many possible variations of this idea to list exhaustively.

Embodiments and features discussed above can be realized in the form of information stored in volatile and/or non-volatile computer or device readable media. This is deemed to include at least media such as optical storage (e.g., CD-ROM), magnetic media, flash ROM, or any current or future means of storing digital information. The stored information can be in the form of machine executable instructions (e.g., compiled executable binary code), source code, bytecode, or any other information that can be used to enable or configure computing devices to perform the various embodiments discussed above. Computer or device readable media is deemed to include at least volatile memory such as RAM and/or virtual memory storing information such as CPU instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. One or more computer readable media storing information for enabling a computing device to perform a process of displaying a graphical user interface control, the process comprising:
assigning a user-authored string of text to the graphical user interface control, the user-authored string of text comprising text to be displayed verbatim as text when the graphical user interface control is displayed, and the user-authored text further comprising embedded parameter references that comprise one or more characters in the string that distinguish the embedded parameter references from the text that is to be displayed verbatim;
parsing the user-authored string of text to identify the embedded parameter references;
identifying interactive graphical user interface controls that correspond to the embedded parameter references; and
displaying the graphical user interface control, which comprises displaying a sentence or phrase comprising the text to be displayed verbatim and the interactive graphical user interface controls, where the interactive graphical user interface controls are displayed in positions in the displayed sentence or phrase that correspond to respective positions of the embedded parameter references in the user-authored string of text.

2. One or more computer readable media storing information for enabling a computer to perform a process according to claim 1, the process further comprising:
receiving a plurality of passed parameters, the passed parameters comprising the user-authored string as a first parameter and the user interface controls, or references thereto, comprising other of the passed parameters.

3. One or more computer readable media storing information for enabling a computer to perform a process according to claim 1, wherein the formatting string is from a markup-language document that defines a graphical user interface.

4. One or more computer readable media storing information for enabling a computer to perform a process according to claim 1, wherein the interactive graphical user interface controls display text as part of the displayed sentence or phrase in accordance with user input directed to the controls.

5. One or more computer readable media storing information for enabling a computer to perform a process according to claim 1, wherein the identifying the interactive graphical user interface controls that correspond to the embedded parameter references is based on correspondence of the order of the embedded parameter references with an order of indicia of the interactive graphical user interface controls.

6. One or more computer readable media storing information for enabling a computer to perform a process according to claim 1, wherein at least one of the interactive graphical user interface controls comprises a drop-down list, a checkbox, a combo box, a spinwheel, a datepicker, or a button.

7. One or more computer readable media storing information for a computer to perform a process of displaying a sentence comprising non-interactive text and interactive text, the process comprising:
executing program code defining an object and a parameter or attribute of the object, the parameter or attribute comprising a string of text, the string of text comprising the sentence, the sentence comprising words, and the string of text further comprising one or more parameter references embedded at respective positions in the sentence;
the executing comprising:
matching the one or more of the parameter references with one or more corresponding interactive graphical user interface controls; and
displaying the sentence and the interactive graphical user interface controls in a graphical user interface, where the interactive graphical user interface controls are displayed in positions of the displayed sentence that correspond to the positions of the parameter references in the string of text.

8. One or more computer readable media storing information for a computer to perform a process according to claim 7, wherein the matching comprises parsing the string of text to identify the parameter references.

9. One or more computer readable media storing information for a computer to perform a process according to claim 7, wherein the program code comprises a document comprising markup language.

10. One or more computer readable media storing information for a computer to perform a process according to claim 9, the markup language comprising hypertext markup language (HTML).

11. One or more computer readable media storing information for a computer to perform a process according to claim 9, the markup language comprising extensible markup language (XML) and the string of text comprising an attribute of an XML node in the document.

12. One or more computer readable media storing information for a computer to perform a process according to claim 7, wherein the displaying comprises displaying the object.

13. One or more computer readable media storing information for a computer to perform a process according to claim 7, wherein the matching comprises determining which interactive graphical user interface objects are associated with the one or more parameter references.

14. One or more computer readable media storing information for a computer to perform a process according to claim 7, wherein the interactive graphical user interface controls display text that are in semantic accordance with the words of the sentence.

15. A computing device configured to be capable of performing a process, the process comprising:
parsing a delimited literal string, the delimited literal string containing a text sentence and one or more markers embedded in the delimited literal string as part of the sentence, the parsing identifying the one or markers; and
displaying the sentence in a graphical user interface, the displaying the sentence comprising displaying, as part of the sentence, in place of the one or more markers, one or more interactive graphical user interface controls that display text as part of the sentence.

16. A computing device configured according to claim 15, wherein the process further comprises identifying the one or more graphical user interface controls that correspond to the one or markers.

17. A computing device configured according to claim 15, the process further comprising receiving one or more passed parameters, the parameters comprising the literal string and one or more references to the graphical user interface controls.

18. A computing device configured according to claim 15, wherein one of the graphical user interface controls comprises a drop-down list and the text of the sentence displayed by the user interface control comprises an entry of the drop-down list.

19. A computing device configured according to claim 15, the process further comprising executing code of which the delimited literal string is a part thereof.

20. A computing device configured according to claim 15, wherein the literal string is received as part of a document comprising markup code and content marked thereby, and the literal string is a parameter of an element of the markup code.
